(19) United States
(12) Patent Application Publication
(10) Pub. No.: US 2007/0235149 A1
(43) Pub. Date: Oct. 11, 2007

(54) Door opening system for a garage door

(75) Inventors: Tomasz Hillar, Elbl G (PL); Michal Trzaskowski, Olsztyn (PL); Urszula Kiszkiel, Bialystok (PL); Czeslaw Trzaskowski, Olsztyn (PL); Sam Wu, Taichung City (TW)

Correspondence Address: ABELMAN, FRAYNE & SCHWAB, 666 THIRD AVENUE, 10TH FLOOR, NEW YORK, NY, 10017, US

(73) Assignee: May TZOU

(21) Appl. No.: 11/392,271

(22) Filed: Mar. 28, 2006

(30) Foreign Application Priority Data
Mar. 25, 2006 (EP) 06251623.2

(51) Int. Cl. E05F 15/00

(52) U.S. Cl. 160/188

(57) ABSTRACT

A door opening system includes a power transmission mechanism, a trolley, and a connecting arm. The power transmission mechanism includes a motor, a drive wheel driven rotatably by the motor, an indirect wheel, and a tension wheel. A transmission rope is trained on the drive, indirect and tension wheels in a closed loop such that parts of the transmission rope extend along a spiral path on the drive and indirect wheels, and do not contact each other, and such that rotation of the drive wheel drives the indirect and tension wheels rotatably. The trolley is coupled to the transmission rope, and is disposed between the indirect and tension wheels of the power transmission mechanism. The connecting arm has a first end coupled to the trolley, and a second end adapted to be coupled to the garage door.

### BACKGROUND OF THE INVENTION

1. Field of the Invention

The invention relates to a door opening system, more particularly to an electrical door opening system for a garage door.

2. Description of the Related Art

A garage door operator (GDO) is for opening and closing garage doors, and generally includes a motor, a transmission mechanism, a trolley, and a connecting arm. At present, the transmission mechanism includes gears that mesh with a chain or a toothed belt. The main disadvantage of the chain transmission mechanism is its complicated and expensive manufacturing process. Moreover, the chain transmission mechanism makes a lot of noise during opening and closing operations of the GDO. In addition, in view of load considerations, it is necessary to supply a huge amount of motive power to drive the chain transmission mechanism.

Some GDOs are equipped with advanced automatic learning functions in order to ensure safety during operations of the GDOs. All wireless control devices with a certain level of safety include a code learning procedure. It is ideal to have all possible functions and to be able to control these functions wirelessly and safely. However, to achieve this, it is required for the users to be aware of signal transactions during the learning procedure. If the number of learned functions is not large, light-emitting diodes (LEDs), for instance, provide an easy way for user interaction. However, if the setup of the wireless control device is not within the user's eyesight, or if the learning operation includes several steps, problems may arise. In addition, when an error signal is generated, the user may be required to flip through the user's manual in order to identify the actual meaning of the error signal.

### SUMMARY OF THE INVENTION

Therefore, the object of the present invention is to provide a door opening system, the manufacturing and assembly processes of which are simplified, and the manufacturing cost of which is reduced.

According to the present invention, there is provided a door opening system for a garage door. The door opening system includes a power transmission mechanism, a trolley, and a connecting arm. The power transmission mechanism includes a motor, a drive wheel driven rotatably by the motor and having a first outer surrounding surface formed with a first groove unit, an indirect wheel having a second outer surrounding surface formed with a second groove unit, a tension wheel having a third outer surrounding surface formed with a third groove, and a transmission rope. The drive, indirect and tension wheels are aligned along a longitudinal direction, and are spaced apart from each other. The indirect wheel is disposed between the drive wheel and the tension wheel. The transmission rope is trained on the drive, indirect and tension wheels in a closed loop such that the transmission rope is received in the first groove unit, the second groove unit and the third groove, such that the parts of the transmission rope that are received in the first and second groove units extend along a spiral path and do not contact each other, and such that rotation of the drive wheel drives the indirect and tension wheels rotatably. The trolley is coupled to the transmission rope, and is disposed between the indirect and tension wheels of the power transmission mechanism. The connecting arm has a first end coupled to the trolley, and a second end adapted to be coupled to the garage door.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary perspective view, illustrating the preferred embodiment of a door operating system according to the present invention when applied to a garage door;

FIG. 2 is a perspective view of a drive wheel, an indirect wheel and a transmission rope according to the preferred embodiment;

FIG. 3 is a fragmentary schematic bottom view of the preferred embodiment, illustrating a power transmission mechanism;

FIG. 4 is a fragmentary schematic side view of the preferred embodiment, illustrating the power transmission mechanism;

FIG. 5 is a fragmentary schematic top view of the preferred embodiment, illustrating the power transmission mechanism;

FIG. 6 is a fragmentary sectional view of the preferred embodiment, taken along line VI-VI in FIG. 4;

FIG. 7 is a schematic block diagram of a double force control system circuit unit of the preferred embodiment; and

FIG. 8 is a schematic block diagram of a main board and a voice module of the preferred embodiment.

### DETAILED DESCRIPTION OF THE PREFERRED EMBODIMENT

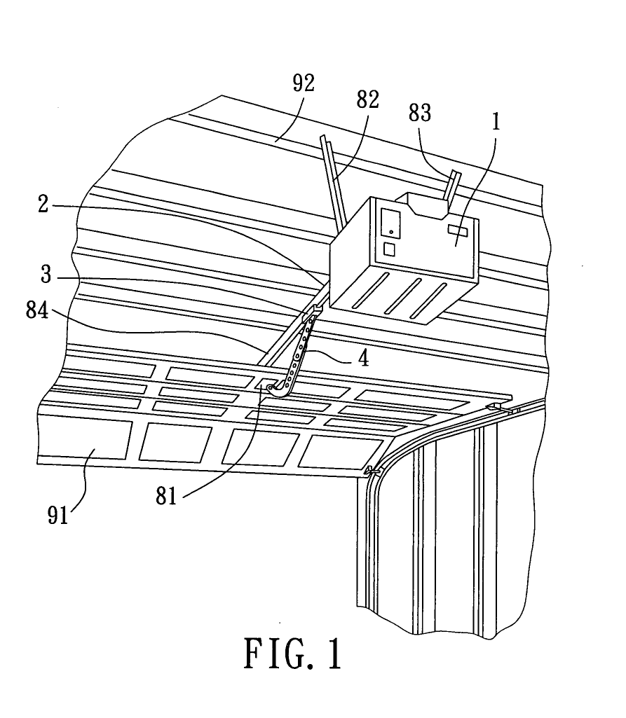

As shown in FIGS. 1, 7 and 8, the preferred embodiment of a door opening system according to the present invention includes a housing 1, a power transmission mechanism 2 partially received in the housing 1, a trolley 3, a connecting arm 4, a main board 5, a rotation sensor 6, and a voice module 7. The main board 5, the rotation sensor 6 and the voice module 7 are disposed in the housing 1.

As shown in FIG. 1, the housing 1 is mounted under a ceiling 92 via two suspending components 82, 83. Part of the power transmission mechanism 2 is mounted movably on a rail 84, which is mounted on the ceiling 92. The trolley 3 is fixed on the power transmission mechanism 2 such that the trolley 3 is movable along the rail 84. The connecting arm 4 has a first end coupled pivotally to the trolley 3, and a second end coupled pivotally to a garage door 91 via a bracket 81. The trolley 3, along with the connecting arm 4, is driven by the power transmission mechanism 2 in order to open and close the garage door 91.

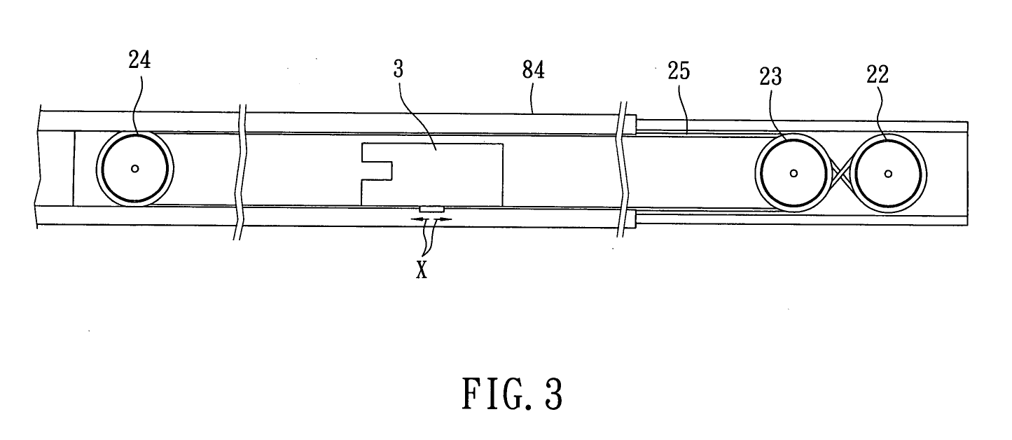

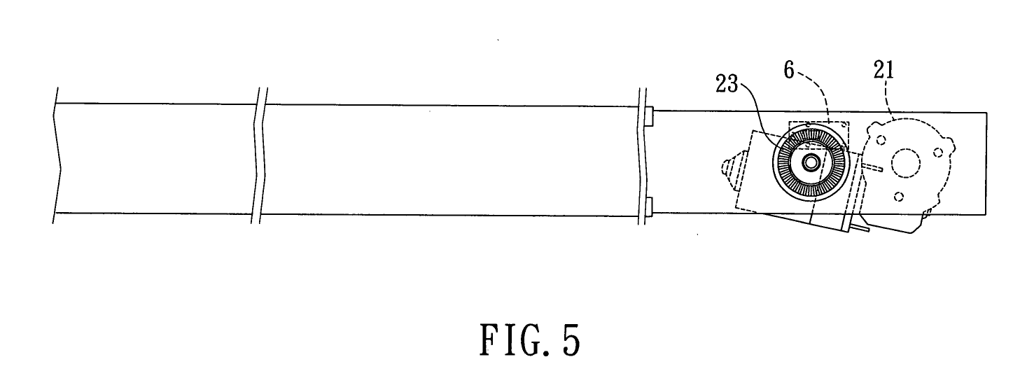

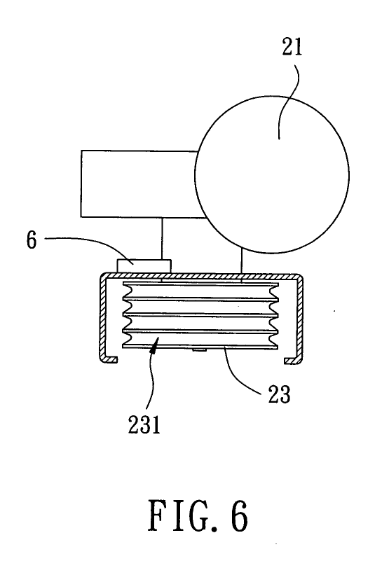

As shown in FIGS. 1 to 6, the power transmission mechanism 2 includes a motor 21, a drive wheel 22, an indirect wheel 23, a tension wheel 24, and a transmission rope 25. As shown in FIG. 3, the drive, indirect, and tension wheels 22, 23, 24 are aligned along a longitudinal direction (X), and are spaced apart from each other. The indirect wheel 23 is disposed between the drive wheel 22 and the tension wheel 24.

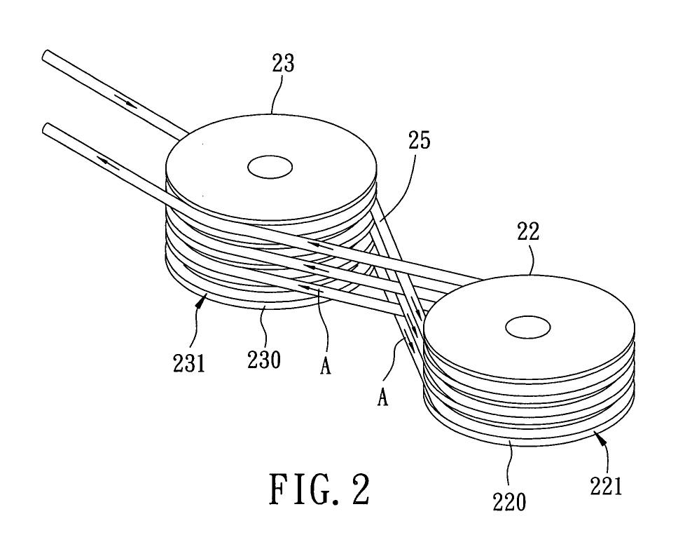

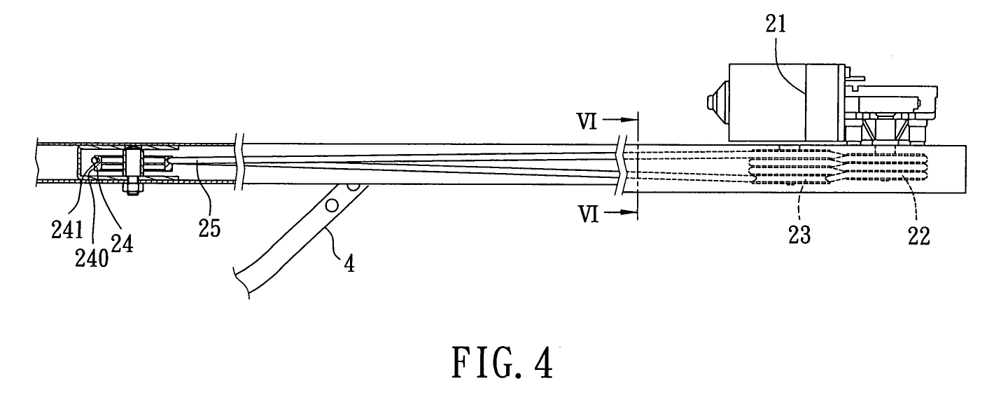

As shown in FIG. 2 and FIG. 4, the drive wheel 22 is driven rotatably by the motor 21, and has a first outer surrounding surface 220 formed with a first groove unit 221 that includes a first number of annular grooves. The indirect wheel 23 has a second outer surrounding surface 230 formed with a second groove unit 231 that includes a second number of annular grooves. The tension wheel 24 has a third outer surrounding surface 240 that is formed with a third groove 241.

The transmission rope 25 is trained on the drive, indirect, and tension wheels 22, 23, 24 in a closed loop such that the transmission rope 25 is received in the annular grooves of the first groove unit 221, the annular grooves of the second groove unit 231 and the third groove 241, such that the parts of the transmission rope 25 that are received in the annular grooves of the first and second groove units 221, 231 extend along a spiral path and do not contact each other, and such that rotation of the drive wheel 22 drives the indirect and tension wheels 23, 24 rotatably. In this embodiment, this is accomplished by making the second number of the annular grooves of the second groove unit 231 one more than the first number of the annular grooves of the first groove unit 221. In particular, the first groove unit 221 includes three annular grooves, whereas the second groove unit 231 includes four annular grooves. It should be noted herein that the first and second numbers are not limited to the particular values provided in this preferred embodiment.

As shown in FIG. 2, parts of the transmission rope 25 form crosses between the drive and indirect wheels 22, 23. Arrows (A) shown in the transmission rope 25 indicate the directions that the transmission rope 25 travels as the drive wheel 22 is driven by the motor 21. Because of this unique configuration of the drive, indirect and tension wheels 22, 23, 24, and the transmission rope 25 according to the present invention, the transmission rope 25 is prevented from fast wear due to frequent frictional contact among parts thereof.

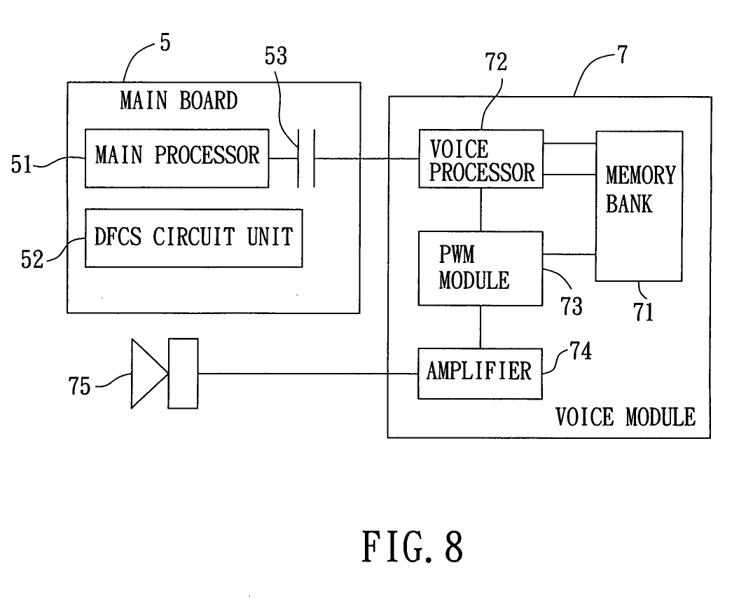

As shown in FIG. 3, the transmission rope 25 forms two parallel parts between the indirect and tension wheels 23, 24. The trolley 3 is disposed between the indirect and tension wheels 23, 24, and is coupled to the transmission rope 25 on one of these two parallel parts. Therefore, as rotational motion of the drive wheel 22 drives the indirect and tension wheels 23, 24 rotatably, the transmission rope 25 between the indirect and tension wheels 23, 24 is driven linearly along the longitudinal direction (X), bringing the trolley 3 in linear motion along the longitudinal direction (X) as well. Referring back to FIG. 1, the trolley 3 brings the connecting arm 4 in motion as a result, which in turn moves the garage door 91 to open or close. As shown in FIGS. 3 to 8, the main board 5 includes a main processor 51, a double force control system (DFCS) circuit unit 52, and a control bus 53 (shown in FIG. 8). The DFCS circuit unit 52 is capable of obtaining the location of the trolley 3.

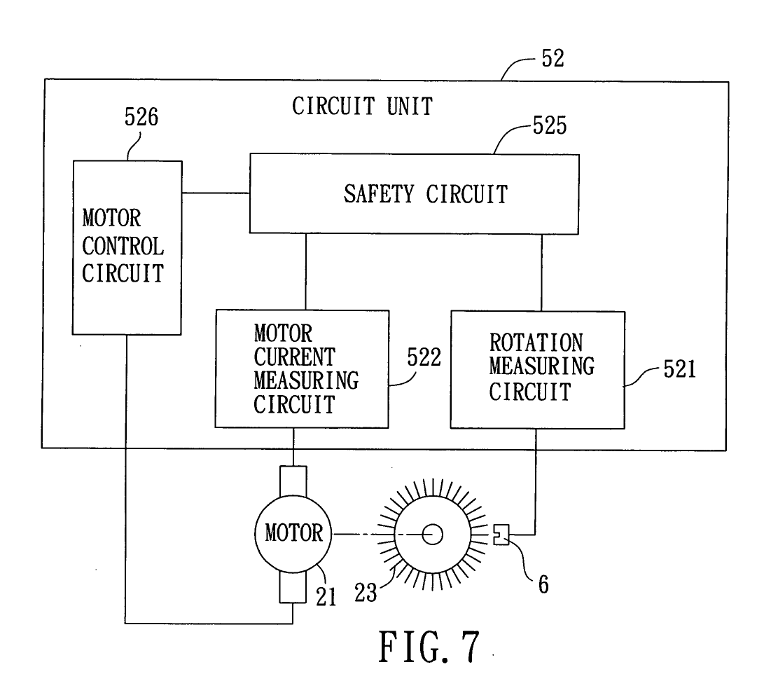

In this embodiment, the motor 21 is a direct current (DC) motor, the rotational speed of which is proportional to the load thereof. The DFCS circuit unit 52 is coupled electrically to the motor 21 and the rotation sensor 6. As shown in FIG. 7, the rotation sensor 6 is integrated with the indirect wheel 23, and generates an output corresponding to rotational speed of the indirect wheel 23. The DFCS circuit unit 52 controls the motor 21 according to at least one of current flowing through the motor 21 and the output of the rotation sensor 6. By utilizing the DFCS circuit unit 52, the door opening system according to the present invention can accurately respond to various circumstances. The DFCS circuit unit 52 is capable of memorizing individually the relationships between characteristics, such as load, location of the trolley 3, etc., and the current during opening and closing operations. As a result, the DFCS circuit unit 52 is capable of supplying the power that is required by the door opening system based on the load and the location of the trolley 3 in order to control the motor 21 properly.

Since measurement of the current flowing through the motor 21 is considerably slow, it is difficult to accurately respond to the dynamics and variations in the rotational speed of the motor 21. Since the DFCS circuit unit 52 has two independent ways of controlling the motor 21, the door opening system is made safer during operation thereof.

As shown in FIG. 7, the DFCS circuit unit 52 includes a rotation measuring circuit 521, a motor current measuring circuit 522, a DFCS safety circuit 525, and a motor control circuit 526. The rotation measuring circuit 521 receives the output of the rotation sensor 6, and transforms it into rotational speed of the indirect wheel 23. The motor current measuring circuit 522 measures the current flowing through the motor 21. The DFCS safety circuit 525 receives the outputs of the rotation measuring circuit 521 and the motor current measuring circuit 522 in order to conduct DFCS safety procedure so as to ensure high safety during operation of the door opening system. Subsequently, the motor control circuit 526 uses the signal outputted by the DFCS safety circuit 525 to control the output power of the motor 21.

As shown in FIG. 8, the main processor 51 generates an identification code for a specific function of the door opening system. The voice module 7 is coupled electrically to the main processor 51 for receiving the identification code from the main processor 51 via the control bus 53, and for generating a voice signal that corresponds to the identification code. In this embodiment, the voice module 7 is in the form of an external interface card that is inserted into a connecting port on the main board 5, i.e., the connecting port that corresponds to the control bus 53. Depending on the language spoken and the market requirements, users can purchase the required voice module 7 for their door opening system.

The voice module 7 includes a memory bank 71, a voice processor 72, a pulse width modulation (PWM) module 73, and an amplifier 74. The memory bank 71 stores a plurality of voice samples. The voice processor 72 is coupled electrically to the main processor 51 and the memory bank 71 for receiving the identification code from the main processor 51, for obtaining the voice samples from the memory bank 71 that correspond to the identification code, and for generating a synthesized output from the voice samples thus obtained. The PWM module 73 is coupled electrically to the voice processor 72 for modulating the synthesized output from the voice processor 72. The amplifier 74 is coupled electrically to the PWM module 73 for amplifying a modulated output from the PWM module 73 so as to result in the voice signal. In this embodiment, the amplifier 74 is coupled to a speaker 75 for audible reproduction of the voice signal in order to notify the users of a particular function of the door opening system.

In conclusion, due to the configuration of the drive, indirect and tension wheels 22, 23, 24, and the transmission rope 25, the manufacturing and assembly processes of the door opening system according to the present invention are simplified, and the manufacturing cost is reduced.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A door opening system for a garage door, comprising:
a power transmission mechanism including
a motor,
a drive wheel driven rotatably by said motor, and having a first outer surrounding surface formed with a first groove unit,
an indirect wheel having a second outer surrounding surface formed with a second groove unit,
a tension wheel having a third outer surrounding surface formed with a third groove,
said drive, indirect, and tension wheels being aligned along a longitudinal direction, and being spaced apart from each other, said indirect wheel being disposed between said drive wheel and said tension wheel, and
a transmission rope trained on said drive, indirect, and tension wheels in a closed loop such that said transmission rope is received in said first groove unit, said second groove unit and said third groove, such that the parts of said transmission rope that are received in said first and second groove units extend along a spiral path and do not contact each other, and such that rotation of said drive wheel drives said indirect and tension wheels rotatably;
a trolley coupled to said transmission rope, and disposed between said indirect and tension wheels of said power transmission mechanism; and
a connecting arm having a first end coupled to said trolley, and a second end adapted to be coupled to the garage door.

2. The door opening system for a garage door as claimed in claim 1, wherein said first groove unit includes a first number of annular grooves, said second groove unit including a second number of annular groves, the second number being one more than the first number.

3. The door opening system for a garage door as claimed in claim 1, further comprising:
a main board including a main processor for generating an identification code for a specific function of said door opening system; and
a voice module coupled electrically to said main processor for receiving the identification code from said main processor, and for generating a voice signal that corresponds to the identification code.

4. The door opening system for a garage door as claimed in claim 3, wherein said voice module includes:
a memory bank for storing a plurality of voice samples;
a voice processor coupled electrically to said main processor and said memory bank for receiving the identification code from said main processor, for obtaining the voice samples from said memory bank that correspond to the identification code, and for generating a synthesized output from the voice samples thus obtained;
a pulse width modulation module coupled electrically to said voice processor for modulating the synthesized output from said voice processor; and
an amplifier coupled electrically to said pulse width modulation module for amplifying a modulated output from said pulse width modulation module so as to result in the voice signal.

5. The door opening system for a garage door as claimed in claim 1, wherein said motor is a direct current motor.

6. The door opening system for a garage door as claimed in claim 5, further comprising:
a rotation sensor for generating an output corresponding to rotational speed of said indirect wheel of said power transmission mechanism; and
a double force control system circuit unit coupled electrically to said motor and said rotation sensor for controlling said motor according to at least one of current flowing through said motor and the output of said rotation sensor.
